(19) United States
(12) Patent Application Publication
(10) Pub. No.: US 2012/0209578 A1
(43) Pub. Date: Aug. 16, 2012

(54) METHOD AND SYSTEM FOR SIMULATING A MONITORING SYSTEM

(76) Inventors: David Victor Stevens, Manchester (GB); John Wesley Grant, Gardnerville, NV (US); Sunil Mandhan, Haryana (IN); Abhishek Janardan Bajare, Akola (IN); Sajith Nair, Thane (IN); Lloyd Michel Rottmann, VC Highlands, NV (US); Sean Afshar Tabrizi, Kennesaw, GA (US)

(21) Appl. No.: 13/029,014

(22) Filed: Feb. 16, 2011

(51) Int. Cl. G06G 7/48

(52) U.S. Cl. 703/6

(57) ABSTRACT

A simulation system includes a display, a processor coupled to the display, and a computer-readable medium coupled to the processor. The computer-readable medium includes at least one monitor module configured to receive at least one input signal and to generate at least one monitor signal based on each input signal received, and a backplane module coupled to the at least one monitor module for generating at least one backplane signal based on each monitor signal received.

### BACKGROUND OF THE INVENTION

The present application relates generally to monitoring systems and, more particularly, to a method and apparatus for simulating a monitoring system.

At least some known machines may exhibit vibrations or other abnormal behavior during operation. To monitor and/or measure such behavior, one or more sensors may be used to determine, for example, an amount of vibration exhibited in a motor drive shaft, a rotational speed of the motor drive shaft, and/or any other suitable operational characteristics of a machine or motor.

Known sensors are often coupled to a monitoring system that includes a plurality of monitors and that gathers data from the sensors. More specifically, in some monitoring systems, each monitor receives measurements from one or more sensors and performs one or more processing steps on the measurements received. The processed measurement signals are then transmitted to a diagnostic platform that displays the measurements to a user.

Because of the amount of processing and monitors required, at least some known monitoring systems may be expensive. Moreover, known monitoring systems may be ineffective in monitoring components of test machines or other devices located in remote locations.

### BRIEF DESCRIPTION OF THE INVENTION

In one embodiment, a simulation system is provided that includes a display, a processor coupled to the display, and a computer-readable medium coupled to the processor. The computer-readable medium includes at least one monitor module configured to receive at least one input signal and to generate at least one monitor signal based on each input signal received, and a backplane module coupled to the at least one monitor module for generating at least one backplane signal based on each monitor signal received.

In another embodiment, a simulator for simulating operation of a monitoring system is provided. The simulator includes at least one sensor module configured to generate at least one sensor signal and at least one monitor module configured to receive the at least one sensor signal and to generate at least one monitor signal based on each sensor signal received. The simulator also includes a backplane module coupled to the at least one monitor module and configured to generate at least one backplane signal based on each monitor signal received.

In another embodiment, a method of representing an operation of a monitoring system is provided that includes receiving at least one sensor signal representative of a measured operating condition of a machine, simulating a response of a monitoring system to each sensor signal received, and providing the simulated response to a user. Simulating a response of a monitoring system includes processing each sensor signal received within at least one monitor module, generating at least one monitor signal based on each sensor signal received by the at least one monitor module, and transforming each monitor signal received into at least one backplane signal.

### BRIEF DESCRIPTION OF THE DRAWINGS

FIG. 1 is a block diagram of an exemplary simulation system that may be used to simulate an operation of a monitoring system.

FIG. 2 is a block diagram of an exemplary simulator that may be used with the simulation system shown in FIG. 1.

FIG. 3 is a flow diagram of an exemplary method of representing an operation of a monitoring system that may be used with the simulation system shown in FIG. 1.

### DETAILED DESCRIPTION OF THE INVENTION

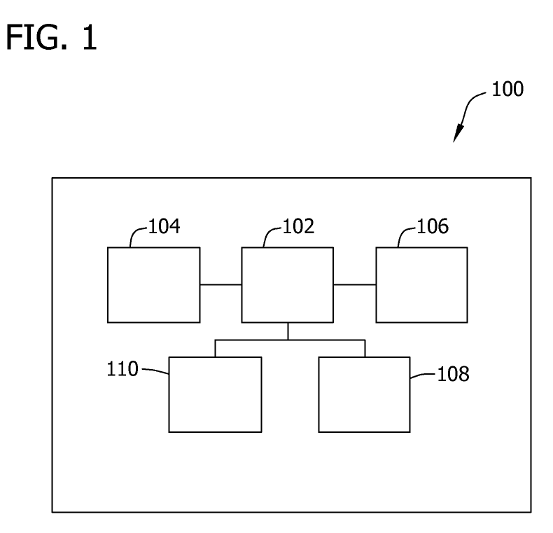

FIG. 1 illustrates a simulation system 100 that may be used to simulate an operation of a monitoring system. In the exemplary embodiment, simulation system 100 includes a processor 102, a display 104, a memory 106, a communication interface 108, and a user interface 110. Each of display 104, memory 106, communication interface 108, and user interface 110 is coupled to, and is in data communication, with processor 102. As used herein, the term “processor” includes any suitable programmable system including systems and microcontrollers, reduced instruction set circuits (RISC), application specific integrated circuits (ASIC), programmable logic circuits (PLC), and any other circuit capable of executing the functions described herein. The above examples are exemplary only, and thus are not intended to limit in any way the definition and/or meaning of the term “processor.” In the exemplary embodiment, display 104 may include, without limitation, a liquid crystal display (LCD), a cathode ray tube (CRT), a plasma display, and/or any suitable visual output device capable of displaying graphical data and/or text to a user.

In the exemplary embodiment, memory 106 may include a computer readable medium, such as, without limitation, a hard disk drive, a solid state drive, a diskette, a flash drive, a compact disc, a digital video disc, random access memory (RAM), and/or any suitable storage device that enables processor 102 to store, retrieve, and/or execute instructions and/or data. Moreover, memory 106 may include one or more local and/or remote storage devices.

Similarly, in the exemplary embodiment, communication interface 108 may include, but is not limited to only including, a network interface controller (NIC), a network adapter, a transceiver, and/or any suitable communication device that enables simulation system 100 to operate as described herein. Communication interface 108 may be configured to connect to a network (not shown) and/or to one or more data communication systems using any suitable communication protocol, such as, but not limited to, an Institute of Electrical and Electronics Engineers (IEEE) 802.3 wired Ethernet protocol or a wireless Ethernet protocol, such as, without limitation, an IEEE 802.11 protocol, an IEEE 802.15 protocol, and/or an IEEE 802.16 protocol.

In the exemplary embodiment, user interface 110 may include, but is not limited to including, a keyboard, a keypad, a mouse, a pointing device, a touch sensitive screen, an audio input device, and/or any suitable device that enables a user to input data into simulation system 100 and/or retrieve data from simulation system 100. In one embodiment, user interface 110 is used to interact with a graphical user interface (GUI) (not shown) displayed on display 104.

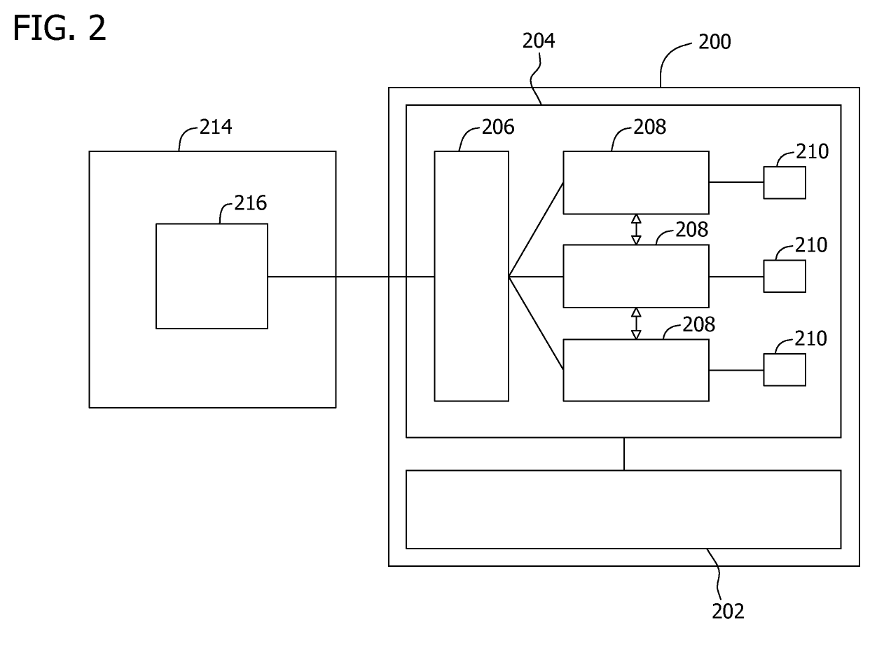

FIG. 2 illustrates a block diagram of an exemplary simulator 200 that may be used with simulation system 100 (shown in FIG. 1). In the exemplary embodiment, simulator 200 is embodied in a computer-readable medium, such as memory 106 (shown in FIG. 1). A processor, such as processor 102 (shown in FIG. 1), executes instructions contained in memory 106 to perform the functions of simulator 200. Alternatively, any suitable system that houses simulator 200 and/or performs the functions of simulator 200, as described herein, may be used. In the exemplary embodiment, simulator 200 includes a graphical user interface (GUI) 202 and a hardware simulator module 204 that is coupled to GUI 202 and that is in data communication with GUI 202.

In the exemplary embodiment, GUI 202 is embodied in memory 106 and is selectively displayed on display 104 (shown in FIG. 1). Moreover, GUI 202 is at least partially operated using user interface 110 (shown in FIG. 1). Alternatively, GUI 202 may be embodied in, displayed on, and/or operated using any suitable system, such as a remote system, that enables simulator 200 to function as described herein. GUI 202 enables a user to operate and/or to interact with hardware simulator module 204. As a result of such interaction, the user may, for example, add, remove, rearrange, couple together, decouple, and/or modify components within hardware simulator module 204.

Hardware simulator module 204, in the exemplary embodiment, includes a backplane module 206, at least one monitor module 208 coupled to backplane module 206, and at least one sensor module 210 coupled to each monitor module 208. As used herein, the term “module” refers to a computer program, dataset, and/or instruction set that is representative of a component or system, such as a hardware component of a monitoring system. In the exemplary embodiment, hardware simulator module 204 includes a plurality of monitor modules 208 and a plurality of sensor modules 210. Sensor modules 210 simulate the operation of one or more sensors, transducers, and/or any suitable measurement device. As used herein, the terms “simulate” and “simulation” refer to a model or representation of the operation of a component or system. For example, during a simulation, one or more inputs are received, and one or more expected outputs of the simulated component or system are generated based on the received inputs. In a specific embodiment, hardware simulator module 204 and/or simulator 200 simulates an operation of a monitoring system, such as a General Electric Company 3500 series machinery protection system. Alternatively, hardware simulator module 204 and/or simulator 200 simulates an operation of any suitable monitoring system.

In the exemplary embodiment, sensor modules 210 generate one or more sensor signals or other input signals that represent one or more measured operating conditions of one or more machines, such as, but not limited to, a gas turbine, a compressor, a motor, and/or any suitable machine. The sensor signals may represent, without limitation, a measured temperature, a measured vibration amplitude, a measured rotational speed, a measured expansion, and/or any suitable measurements or detected conditions of one or more components of a machine. In the exemplary embodiment, each sensor module 210 is coupled to a respective monitor module 208, such that each module 208 receives at least one sensor signal or other input signal from modules 210. Alternatively, sensor modules 210 are coupled to backplane module 206, and sensor modules 210 transmit sensor signals to monitor modules 208 via backplane module 206. In an alternative embodiment, simulator 200 does not include sensor modules 210, but rather data representing one or more sensor signals are provided from a file, database, or other suitable structure stored within a memory, such as memory 106. In another embodiment, simulator 200 receives one or more sensor signals from one or more physical sensors operatively coupled to a machine. In yet another embodiment, sensor modules 210 are positioned and/or embodied within an external system (not shown) that is remote from simulator 200, and the external system transmits the sensor signals to simulator 200 through a network or other suitable data conduit.

Each sensor module 210, in the exemplary embodiment, simulates and/or measures a different operating condition of the machine from each other sensor module 210. Alternatively, multiple sensor modules 210 may be included that measure the same operating conditions (i.e., one or more duplicate sensor modules 210 may be provided). Sensor modules 210 may generate any suitable number and/or frequency of sensor signals. For example, modules 210 may generate sensor signals at predetermined intervals, continuously, at a predetermined frequency, and/or at a variable frequency. Characteristics of sensor modules 210 and/or the sensor signals can be suitably adjusted using GUI 202. For example, GUI 202 may enable adjustments to a sensor signal amplitude, a sensor signal offset and/or basis, a number of sensor signals generated by sensor modules 210, and/or any other characteristic of sensor modules 210 and/or the sensor signals.

Monitor modules 208 are coupled to sensor modules 210 and receive sensor signals transmitted from sensor modules 210. Each monitor module 208 processes at least one sensor signal and/or measured operating condition received from sensor modules 210. As used herein, the term “process” refers to performing an operation on, adjusting, and/or altering at least one characteristic of a sensor signal or other suitable component of simulator 200. In the exemplary embodiment, the sensor signals are transmitted to monitor modules 208 in digital format. In one embodiment, monitor modules 208 receive one or more sensor signals from an external system and/or from physical sensors rather than from sensor modules 210, and monitor modules 208 transform the sensor signals into a digital form before processing the sensor signals.

In the exemplary embodiment, each monitor module 208 processes a different sensor signal from the remaining monitor modules 208. Alternatively, one or more duplicate monitor modules 208 may process the same sensor signals. Monitor modules 208 process each sensor signal by synchronizing the sensor signal with one or more reference signals and/or other sensor signals, by adjusting an amplitude of the sensor signal, by adjusting a frequency and/or a phase offset of the sensor signal, by combining the sensor signal with one or more other sensor signals and/or other suitable signals, and/or by storing one or more values representing the sensor signal in memory 106 and/or in any suitable local and/or remote memory device. Monitor modules 208 may also buffer and/or increase a delay to the sensor signals as desired. Moreover, monitor modules 208 may generate one or more status signals associated with one or more sensor signals. For example, modules 208 may generate signals indicative of a sensor drift, signals indicative of whether the sensor signals are within an expected amplitude or frequency range, and/or signals indicative of sensor error or status. Monitor modules 208 may also generate alarm signals if a sensor signal satisfies a predetermined alarm condition, i.e., a sensor signal exceeds a predetermined amplitude or frequency threshold.

Monitor modules 208 may also store physical data about the machine, sensor modules 210, and/or any other suitable component of the monitoring system in memory 106 and/or in any suitable local and/or remote memory device. For example, monitor modules 208 may store data representing an orientation of one or more sensors represented by sensor modules 210, a rotational direction of a drive shaft and/or any other component of the machine, a geometry and/or any other characteristic of a compression chamber of the machine, and/or any other physical property or information regarding one or more components of the monitoring system. Moreover, monitor modules 208 and/or simulator 200 may process or otherwise combine the stored physical data with one or more received sensor signals as described herein.

Each monitor module 208, in the exemplary embodiment, generates one or more monitor signals based on each sensor signal received. More specifically, each monitor module 208 transforms the sensor signals and/or the stored physical data into one or more monitor signals that are transmitted from monitor modules 208 to backplane module 206 after being processed by modules 208. In the exemplary embodiment, monitor modules 208 may transform the sensor signals into a bus protocol or any other signal format that is suitable for communication with backplane module 206. Moreover, monitor modules 208 may communicate with each other and/or with backplane module 206, i.e., monitor signals and/or other suitable signals may be transmitted from one monitor module 208 to another monitor module 208 and/or to backplane module. More specifically, monitor modules 208 may communicate with each other via backplane module 206 and/or directly between monitor modules 208. Such monitor signals may include, but are not limited to including, the processed sensor signals, status signals, alarm signals, signals representing stored physical data of one or more components of the monitoring system, and/or any other suitable signal.

Backplane module 206 generates at least one backplane signal based on each monitor signal received from monitor modules 208. More specifically, backplane module 206 receives monitor signals from monitor modules 208 and transforms each monitor signal into one or more backplane signals. In a specific embodiment, backplane module 206 transforms monitor signals having a first signal format and/or protocol into backplane signals that have a second signal format and/or protocol. In the exemplary embodiment, the monitor signals are transmitted in a signal format wherein signal values are represented in digital amplitude values. Backplane module 206 converts the digital amplitude values to a voltage equivalent value, that is then converted to a suitable signal type and value based on the type of monitor signal received. For example, the signal type may include, without limitation, meters, seconds, amperes, watts, volts, and/or any suitable measurement type. In one embodiment, backplane module 206 combines, processes, and/or stores the monitor signals in memory 106 and/or within any suitable memory. Backplane module 206 transmits the backplane signals to a display system 214 wherein the signals are displayed on display system 214 using any combination of graphics and/or text that enables a user to view results of a simulation and/or an operation of simulator 200.

In one embodiment, display system 214 is embodied within simulation system 100. In such an embodiment, display system 214 displays the simulation results (i.e., the simulated operation of the monitoring system) on display 104. Alternatively, display system 214 may be a remote computer and/or other suitable system that enables display system 214 and simulator 200 to function as described herein. In the exemplary embodiment, display system 214 implements a monitoring software 216 that reformats and/or displays at least one aspect of the backplane signals. For example, the monitoring software may display charts, waveforms, trends, data plots, graphs, levels, alarm values, status values, and/or any combination of graphical and/or textual images that are representative of one or more aspects of simulator 200 and/or one or more components and/or outputs of simulator 200. By receiving simulated measurements from simulator 200, display system 214 and/or monitoring software 216 may be tested to determine if one or more aspects, such as one or more charts, graphs, trends, waveforms, and/or any other aspect of display system 214 and/or monitoring software 216 function or operate as expected.

Outputs from simulator 200 may be stored locally or remotely, with any suitable frequency. Moreover, each module and/or component of simulator 200 may be modified and/or updated locally, such as via a CD, a user interface 110, a flash drive, and/or any suitable media or device. Additionally or alternatively, each module and/or component of simulator 200 may be modified and/or updated remotely, via communication interface 108 (shown in FIG. 1), a network, and/or any other suitable remote interface, media, and/or conduit.

During operation, simulator 200 receives sensor signals from sensor modules 210, from data stored in a database or file, and/or from an external system. The sensor signals are representative of measured operating conditions of a machine or device being monitored and/or simulated. The sensor signals are transmitted to monitor modules 208 in a digital format. If the sensor signals are received in an analog format, simulator 200 transforms the sensor signals to digital format before the sensor signals are transmitted to monitor modules 208. Alternatively, monitor modules 208 transform the sensor signals to digital format.

Each monitor module 208 processes the sensor signals and transmits at least one signal to other monitor modules 208. For example, a first sensor module 210 may measure a rotational speed of a machine drive shaft and transmit a first sensor signal including a timing measurement based on the measured rotational speed. A first monitor module 208 may receive the first sensor signal, including the timing measurement, from the first sensor module 210 and may transmit the first sensor signal, after processing the first sensor signal, to one or more monitor modules 208, such as a second monitor module 208. Alternatively, a first monitor module 208 may transmit the first sensor signal without processing it to one or more monitor modules 208. The second monitor module 208 receiving such a signal, whether processed or unprocessed, may combine the timing measurement with one or more measurement signals received from a second sensor module 210 to compile a composite monitor signal. Additional sensor signals and/or measurement signals may be combined to generate the composite monitor signal.

In the exemplary embodiment, each monitor module 208 generates at least one monitor signal that is transmitted to backplane module 206. Backplane module 206 combines, processes, and/or stores the monitor signals before transforming the monitor signals into one or more backplane signals. More specifically, in the exemplary embodiment, backplane module 206 transforms the monitor signals having a first signal format to one or more backplane signals that have a second signal format, prior to transmitting the backplane signals to display system 214. In the exemplary embodiment, display system 214 reformats, reconfigures, and/or processes the backplane signals for display, and displays the results or operations of simulator 200 and/or aspects of the machine or device being monitored and/or simulated.

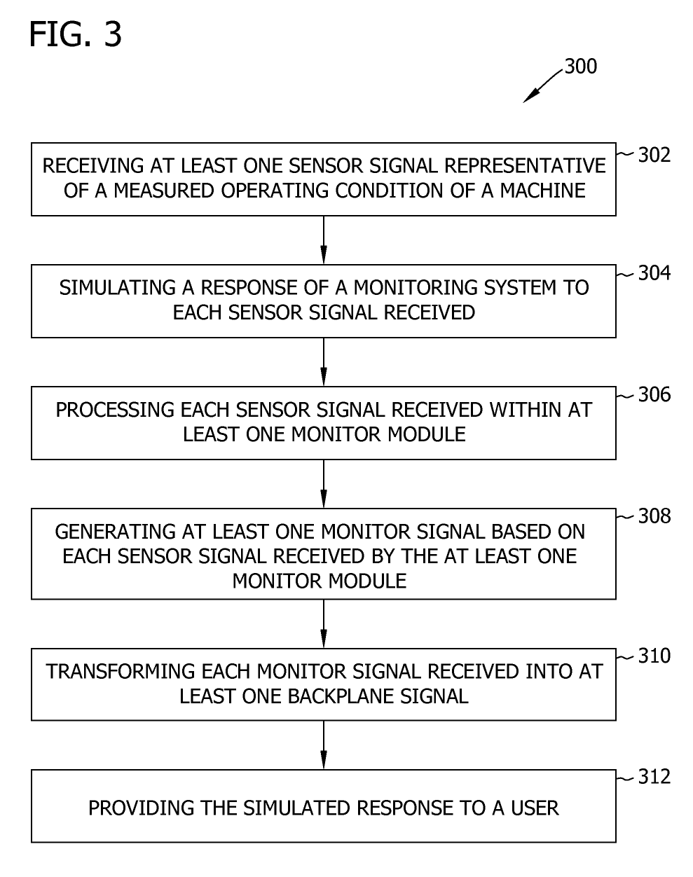

FIG. 3 shows an exemplary method 300 of representing or simulating an operation of a monitoring system. In the exemplary embodiment, method 300 is implemented using simulation system (shown in FIG. 1) and simulator 200 (shown in FIG. 2). Method 300 includes receiving 302 at least one sensor signal that is representative of a measured operating condition of a machine being monitored and/or simulated. A response of the monitoring system to each sensor signal received is simulated 304 by a suitable simulator, such as simulator 200. More specifically, during simulation 304, each sensor signal received 302 is processed 306 within at least one monitor module 208 (shown in FIG. 2), and at least one monitor signal is generated 308 by the at least one monitor module 208. Each monitor signal is then transformed 310 into at least one backplane signal. The result of simulation 304 (i.e., the simulated response of monitoring system to each sensor signal received 302) is provided 312 to a user, such as by displaying the simulated response on a display. More specifically, in the exemplary embodiment, the backplane signals are transmitted to display system 214 (shown in FIG. 1) which reformats, configures, and/or processes the backplane signals for display. The operation of a monitoring system and/or a machine being monitored and/or simulated may be observed by viewing the simulation response and/or the simulation results on display system 214. Moreover, an operation of display system 214 and/or monitoring software 216 may be verified using simulator 200 by viewing the simulation response and/or the simulation results and comparing the simulation response and/or the simulation results with an expected response and/or result.

In the exemplary embodiment, each sensor signal is transformed into digital format. Alternatively, in generating 308 at least one monitor signal, at least two sensor signals received are combined or each sensor signal is processed 306 or each sensor signal is stored in a memory, and/or each sensor signal is synchronized with a reference signal. In another embodiment, each monitor signal is transformed 310 into at least one backplane signal, wherein at least one monitor signal is received having a first signal protocol and is transformed 310 into at least one monitor signal having a second signal protocol. In a further alternative embodiment, at least one backplane signal is generated based on each transformed monitor signal. In one embodiment, each monitor signal is transformed 310 into a second signal protocol as described herein by processing each monitor signal within a backplane module, such as backplane module 206 (shown in FIG. 2).

As a result, simulator 200 facilitates enabling an operation of a machine or device to be represented in a cost-effective manner. Moreover, simulator 200 facilitates enabling an operation of display system 214 and/or monitoring software 216 to be verified. Simulator 200 enables a user to simulate and/or import sensor data and/or other suitable data representative of one or more operating characteristics or aspects of the machine. Simulator 200 simulates a response of a monitoring system to the data and displays the results of the simulation on display system 214. As such, simulator 200 enables the operation of a machine, a monitoring system, and/or a display system to be represented and/or verified. Moreover, simulator 200 enables the operation of remote systems and/or machines to be represented. For example, if a machine located in a remote facility experiences a failure or error, then sensor data and/or any other suitable data gathered from the failure or error may be imported into simulator 200 for troubleshooting. Simulator 200 may process the sensor data and display the processed data on display 214, as described herein, to facilitate identifying the cause of the failure or error.

A technical effect of the systems and method described herein includes at least one of: (a) receiving at least one sensor signal representative of a measured operating condition of a machine; (b) simulating a response of a monitoring system to each sensor signal received; and (c) providing the simulated response to a user.

The above-described embodiments provide an efficient and cost-effective device that may be used to simulate a machine monitoring system. The simulator and simulation systems described herein facilitate modeling or representing an operation of a monitoring system, such as by simulating and/or processing sensor signals representative of measurements of one or more aspects of a machine or device being monitored and/or simulated. One or more sensors, monitor modules, and/or backplane modules are simulated, and an operation of the simulator is displayed on a display system. As such, a monitoring system may be replaced by the simulator to reduce costs. By receiving simulated measurements from the simulator, a display system may be tested to determine if one or more displays, such as one or more charts, graphs, trends, and/or waveforms of the display system function or operate as expected. The simulator and/or simulation system may also be used to train operators to use the display system, the monitoring system, and/or the machine or device under test. The simulator and/or simulation system may be used to test machines, devices, and/or stored data located remotely from the simulator and/or simulation system.

Exemplary embodiments of a simulator, simulation system, and method for simulating a monitoring system are described above in detail. The method, simulator, and simulation system are not limited to the specific embodiments described herein, but rather, components of the simulator and/or simulation system and/or steps of the method may be utilized independently and separately from other components and/or steps described herein. For example, the simulator may also be used in combination with other monitoring systems and methods, and is not limited to practice with only a machine monitoring system as described herein. Rather, the simulator can be utilized in connection with many other power systems, devices, machines, and applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A simulation system comprising:
a display;
a processor coupled to said display; and
a computer-readable medium coupled to said processor, said computer-readable medium comprising:
at least one monitor module configured to receive at least one input signal and to generate at least one monitor signal based on each input signal received; and
a backplane module coupled to said at least one monitor module for generating at least one backplane signal based on each monitor signal received.

2. A simulation system in accordance with claim 1, wherein said at least one monitor module is further configured to at least one of combine each input signal received with at least one other input signal received, process the at least one input signal, store the at least one input signal, and synchronize the at least one input signal.

3. A simulation system in accordance with claim 1, wherein said at least one monitor module is further configured to transmit at least one monitor signal that includes at least one of an alarm signal, a status signal, a signal representing stored physical data of at least one component of a monitoring system, and a processed sensor signal to said backplane module.

4. A simulation system in accordance with claim 1, wherein said computer-readable medium is further configured to simulate an operation of a monitoring system.

5. A simulation system in accordance with claim 4, wherein said simulation system is further configured to display the operation of the monitoring system operation on said display.

6. A simulation system in accordance with claim 1, wherein said computer-readable medium further comprises at least one sensor module configured to generate at least one input signal.

7. A simulation system in accordance with claim 1, wherein said backplane module is further configured to transform at least one monitor signal received having a first signal protocol to at least one backplane signal having a second signal protocol.

8. A simulator for simulating operation of a monitoring system, said simulator comprising:
at least one sensor module configured to generate at least one sensor signal.
at least one monitor module configured to receive the at least one sensor signal and to generate at least one monitor signal based on each sensor signal received; and
a backplane module coupled to said at least one monitor module and configured to generate at least one backplane signal based on each monitor signal received.

9. A simulator in accordance with claim 8, wherein said at least one monitor module is further configured to at least one of combine each sensor signal received with at least one other sensor signal received, process the at least one sensor signal, store the at least one sensor signal, and synchronize the at least one sensor signal.

10. A simulator in accordance with claim 8, wherein said simulator is embodied in a computer-readable medium coupled to a processor.

11. A simulator in accordance with claim 8, wherein said at least one monitor module is further configured to transmit at least one monitor signal that includes at least one of an alarm signal, a status signal, a signal representing stored physical data of at least one component of the monitoring system, and a processed sensor signal to said backplane module.

12. A simulator in accordance with claim 8, comprising at least two said monitor modules, wherein a first monitor module of said at least two monitor modules is further configured to transmit at least one monitor signal that includes at least one of an alarm signal, a status signal, and a processed sensor signal to a second monitor module of said at least two monitor modules.

13. A simulator in accordance with claim 8, wherein said simulation system further comprises a graphical user interface configured to enable a user to adjust at least one characteristic of said at least one sensor module.

14. A simulator in accordance with claim 8, wherein said backplane module is further configured to transform at least one monitor signal received having a first signal protocol to at least one backplane signal having a second signal protocol.

15. A method of representing an operation of a monitoring system, said method comprising:
receiving at least one sensor signal representative of a measured operating condition of a machine;
simulating a response of a monitoring system to each sensor signal received, said simulating a response of a monitoring system comprising:
processing each sensor signal received within at least one monitor module;
generating at least one monitor signal based on each sensor signal received by the at least one monitor module; and
transforming each monitor signal received into at least one backplane signal; and
providing the simulated response to a user.

16. A method in accordance with claim 15, wherein said providing the simulated response to a user comprises displaying the simulated response on a display.

17. A method in accordance with claim 15, wherein said simulating a response of a monitoring system further comprises transforming each sensor signal received into a digital format.

18. A method in accordance with claim 15, wherein said generating at least one monitor signal further comprises at least one of combining at least one sensor signal received with at least one other sensor signal received, processing the at least one sensor signal, storing the at least one sensor signal, and synchronizing the at least one sensor signal.

19. A method in accordance with claim 15, wherein said transforming the at least one monitor signal into at least one backplane signal further comprises:
receiving at least one monitor signal having a first signal protocol;
transforming each monitor signal received into a second signal protocol; and
generating at least one backplane signal based on each transformed monitor signal.

20. A method in accordance with claim 19, wherein said transforming each monitor signal received into a second signal protocol further comprises processing each monitor signal within a backplane module.
